(19) United States
(12) Patent Application Publication
(10) Pub. No.: US 2018/0349812 A1
(43) Pub. Date: Dec. 6, 2018

(54) FORM GENERATION AND EXTERNALIZIATION IN WORKFLOW EXECUTION

(71) Applicant: Xerox Corporation, Norwalk, CT (US)

(72) Inventors: Jose Miguel Perez Alvarez, Tomares (ES); Mario Cortes Cornax, Grenoble (FR); Adrian C. Mos, Meylan (FR)

(21) Appl. No.: 15/610,889

(22) Filed: Jun. 1, 2017

(51) Int. Cl. G06Q 10/06

(52) U.S. Cl. CPC G06Q 10/0633; G06Q 10/067

(57) ABSTRACT

Methods, systems, and devices for form generation and externalization in a workflow execution. In an example embodiment, steps or operations can be provided for mapping form fields and data attributes for one or more electronic forms using a textual domain specific language, wherein the electronic form is based on relations with objects (e.g., data objects), configuring the electronic form with the form fields and the data attributes mapped using the textual domain specific language; and connecting the electronic form (or forms) to a domain specific activity so that the electronic form is thereafter consistently and repetitively reusable across a process collection and automatically connected to generated process activities.

### TECHNICAL FIELD

Embodiments are generally related to data processing and data-management systems and methods. Embodiments additionally relate to Business Process Management (BPM) and Service Oriented Architecture (SOA) technologies. Embodiments further relate to the generation of complex integrated development environments for domain-specific processes that incorporate user forms that assist in managing objects that flow in a workflow.

### BACKGROUND

Business Process Management (BPM) and Service Oriented Architecture (SOA) technologies are two significant aspects of business enterprise solutions. BPM addresses the methodology and tools that enable the management of business processes (BPs) as they evolve throughout their life cycles. A Business Process Management Suite (BPMS) executes business processes and connects them to various enterprise resources, such as a personnel directory, various legacy applications, and, in some cases, to the organization's SOA. An enterprise SOA typically manages the reusable technical services used to execute tasks that occur in business processes. Their functionality, granularity, and interfaces define their level of reuse across a multitude of business processes. In general, the closer the SOA services match the business requirements, the faster it is to implement new business processes.

Business process design is used in Business Process Management (BPM) and enables the expression of the inner workings of business processes to render them executable. This complements and improves the classical business application development practices where requirements are typically passed on to developers that create the application. Business processes (BPs) are often modeled by business-oriented users who have a good business knowledge and understanding of the various roles in the organization, but who are not necessarily familiar with the details of the Information Technology (IT) services that will ultimately be used to implement the processes in the SOA.

Using BPM, business analysts can design, manage, and control business processes themselves up to the execution and analysis of the results. Business-oriented users typically use a language such as Business Process Model and Notation (BPMN) to describe a business process. BPMN is a generic language, which has flowchart-like metaphors and a number of other elements that are useful for business process design. This language contains elements such as activity, gateway, signal, and flow. Users often describe their BPs by assigning textual labels such as perform payment or register customer to the generic BPMN elements. Once the business process descriptions are created, a BPMN editor enables users to assign roles from the organization's hierarchy to human activities, to generate forms for manual tasks, to write business rules in scripting languages to condition various execution flows as well as to conned certain tasks to SOA services, among other features. The business analysts may create the process designs graphically using BPMN with the goal of eventually executing the processes on an appropriate infrastructure supported by the BPMS.

Previously, domain-specific process designs have focused on a behavioral perspective. These approaches defined the activities (or steps) that are to be performed in a process. For example, in a process outsourcing process, relevant activities to be captured and defined include scan a document, perform OCR, and extract keywords. The behavioral description relies on the notion of an activity type (also known as domain concepts), which corresponds to the organization know-how description.

These activity types are linked to the defined process steps in order to capture the process design in an enriched and specific way. Also, an important effort has been implemented to integrate data in the domain specification.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide improved methods, systems, and devices for generating complex integrated development environments for domain-specific processes that incorporate user forms that assist in managing objects that flow in a workflow.

It is another aspect of the disclosed embodiments to provide for methods, systems, and devices for form generation externalization in a workflow execution.

The aforementioned aspects and other objectives and advantages can now be achieved as described herein. Methods and systems are disclosed for form generation and externalization in a workflow execution. In an example embodiment, steps or operations can be provided for mapping form fields and data attributes for one or more electronic forms using a textual domain specific language, wherein the electronic form is based on relations with objects (e.g., data objects), configuring the electronic form with the form fields and the data attributes mapped using the textual domain specific language; and connecting the electronic form (or forms) to a domain specific activity so that the electronic form is thereafter consistently and repetitively reusable across a process collection.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic diagram of a form externalization system, in accordance with an example embodiment;

FIG. 2 illustrates a UML class diagram extending a DomainMM (Domain Metal-Model) to define and support form externalization, in accordance with an example embodiment;

FIG. 3 illustrates a schematic diagram depicting form definition in the domain, in accordance with an example embodiment;

FIG. 4 illustrates a flow diagram depicting a method of form display during process execution, in accordance with an example embodiment;

FIG. 5 illustrates a block diagram depicting a technology-oriented architecture of an implemented prototype, in accordance with an example embodiment;

FIG. 6 illustrates a schematic view of a computer system/apparatus, in accordance with an embodiment; and

FIG. 7 illustrates a schematic view of a software system including a module, an operating system, and a user interface, in accordance with an embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully herein after with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems/devices. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Additionally, the term “step” can be utilized interchangeably with “instruction” or “operation.”

Current workflow management solutions mostly rely on the Business Process Model and Notation (BPMN) language, which is the de-facto standard for business process modeling. However, BPMN has no support for form definition. Forms are used in business process management systems (BPMS) as interface between the users and the process engine. In a process model, if a task is defined as “user task,” this will imply the display of a form where the user will fill several fields and submit them in order to update the process data. Once the user submits the form, the process engine continues executing the following tasks.

The fact that the process modeling standard does not support the definition of forms results in a great number of platform-specific solutions for form management in different BPM tools. Indeed, current BPM tools tend to “force” the process designer to define and manage the process's forms (as well as for data objects definitions) in a tightly coupled way with the design platform. This limits the design capabilities for designers that become dependent on the target platform. If an organization decides to move to another BPM platform, or has to adopt a specific workflow engine, the form migration could be very costly and error prone. These platforms may propose to import some external forms, but an important platform-specific integration effort would be necessary.

These aspects are valid also for generic software systems that require user input in the execution of various sequences of operations assuming they use modeling to describe them.

In order to face the BPMN genericity and complexity, previous work focused on the generation of domain-specific studios in order to enable analysts to design their processes in a more intuitive way. A DSL (Domain Specific Language) can be used as an effective means to cope with application domains providing improvements in expressiveness and ease of use. However, form definition based on the defined data objects has not been supported in previous work; it has to be defined by in an ad-hoc manner, using platform-specific tools.

The approach discussed herein is based on a domain-specific approach that deals with the form definition of the process independently from any design platform. This is a critical and important feature. For example, an organization may need to manage forms out-of-the-box, but at the same time, be able to easily connect them to different processes and dependent data objects. Indeed, this solution partly depends on data object externalization. With the disclosed solutions, users will have a functional form based on the relations with the data objects. As will be discussed in more detail, form fields and the data attributes can be mapped using a simple textual DSL. The forms can then be connected to the domain specific activities. These forms can be consistently and repetitively reused across a process collection.

The interest of the approach is twofold. First, the solution automatically generates the forms relying on the related data. Second, using extensible generation patterns, the necessary BPMN activities to display the aforementioned forms will also be generated. This means that the disclosed approach does not extend BPMN but generates extra BPMN artifacts relying on the enriched semantics of the domain-specific process models.

With this approach, different specific target platforms can be easily targeted with much less effort than current solutions. This is a critical issue when different customers require different BPM platforms from various vendors (e.g., Activiti, Camunda, Bonita, Tibco, IBM, Oracle, etc.). The model-driven generative approach automatically creates a form repository from the corresponding domain-specific model and exposes them as enriched HTML files. The generated HTML files can be easily accessible from any process engine.

In case of generic applications that are not BPMN centric, the generated code can similarly deal with the extra steps needed to connect to the forms. The solution can be fully integrated with current architectures. The appropriateness and the feasibility of this approach are demonstrated through a use case and the integration of the prototype implementation is in advanced state.

The varying embodiments discussed herein describe various methods, systems, and devices for form generation and externalization in a workflow execution. As will be discussed in more detail herein, in an example embodiment, steps or operations can be provided for mapping form fields and data attributes for one or more electronic forms using a textual domain specific language, wherein the electronic form is based on relations with objects (e.g., data objects), configuring the electronic form with the form fields and the data attributes mapped using the textual domain specific language; and connecting the electronic form (or forms) to a domain specific activity so that the electronic form is thereafter consistently and repetitively reusable across a process collection and automatically connected to generated process activities.

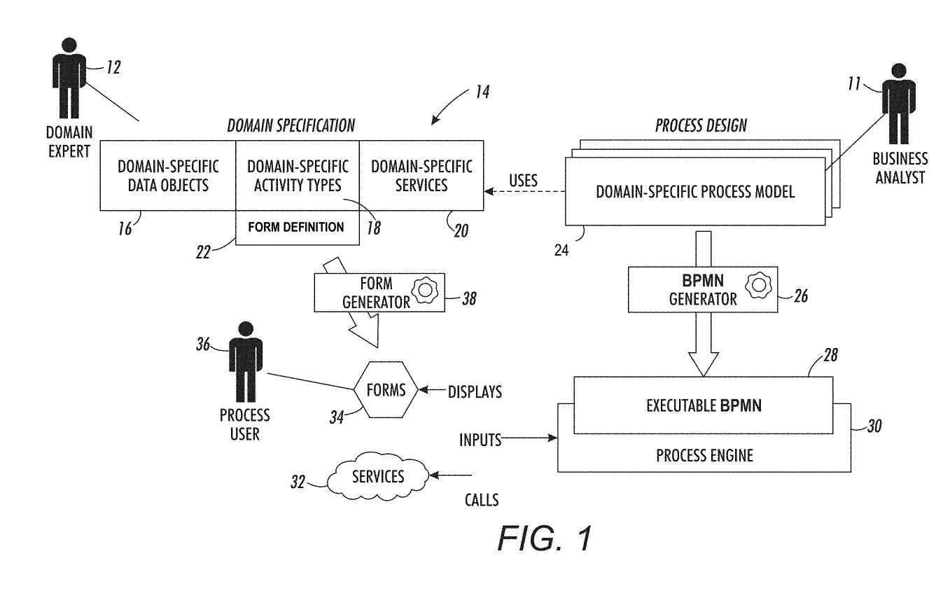

FIG. 1 illustrates a schematic diagram of a form externalization system, in accordance with an example embodiment. The system includes a domain specification 14 composed of domain-specific objects 16, domain-specific activity types 18, a form definition 22, and domain-specific services 20. A domain expert 12 can perform the domain specification. A business analyst 11 can realize the process design. The domain-specific process model 24 can be provided as input to a BPMN generator 26, which in turn outputs an executable BMPN 28, which is executed in a process engine 30. Calls to the services 32 can be performed from the process engine 30. Inputs from the forms 34 can also be provided to the process engine 30. Additionally, data indicative of displays can be provided by the process engine 30 to the forms 34 (i.e., at least one electronic form).

The top of FIG. 1 illustrates the decoupling between the domain-specification and the process design. On the left part side of FIG. 1, the domain-specification 14 includes the Domain-Specific Services 20, the Domain-Specific Activity Types 18, the Domain-Specific Data Objects 16, and Form Definition 22. The Domain Expert 12 defines the organization domain independently of any process definition. The DSActivityTypes 18 refer to behavioral components in a domain that can be encapsulated independently (e.g., Perform an Optical Character Recognition (OCR)). The DSServices 20 correspond to a technical artifacts that imply automatic processing. For example, the latter DSActivityType 18 can be related to a DSService 20 that actually performs the OCR (in the case of the OCR example mentioned above). Data Object 16 corresponds to data entities that flow in the process. Finally, the Form Definition 22 deals with the user interactions within the process. The domain specification 14 is provided as input to a form generator 38, which provides electronic forms 34 as output, which are accessible by a process user 36.

On the right hand side part of FIG. 1, the Domain-Specific Process Model 24 is represented, which uses the elements defined in the domain in order to represent the process. Several domain-specific process models can use the same domain specification 14. Here, the Business Analyst 11 can build the domain-specific process (DSP) that connects the different steps that refer to the DSActivityTypes 18 that were previously defined in the domain model. This link between the process steps and the DSActivityType 18 gathers the information about the related DSServices 20, DSDataObjects 16, and Forms 34.

As these process models focus on a specific domain, they are much easier to understand and build than BPMN for a business analyst. At the same time, the models keep the knowledge defined on the domain specification. If the domain-specific process model is precise enough, the final generated BPMN model can be deployed and executed for a given execution engine. With the incorporation of the form definition, the necessary binding between the user interactions (i.e., inputs and outputs) and the underlying data-model will be achieved.

As FIG. 1 illustrates, an automatic generation of forms can be implemented. The usefulness of the approach does not reside in the actual generation, but on the integration mechanism concerning the domain model definition and the process model that will be executed. This solution can be utilized to outsource the forms 34 from any target engine.

The definitions below can be utilized to externalize the form definition from the process definition.

Form: A web page that serves as an interface between a user and a process engine. A form contains a set of fields, which can be mapped to the process variables.

FormRelation: This term can define the link between an activity type and the corresponding form. FormRelation can contain read field mappings and write field mappings that correspond to read-only fields and write fields, respectively.

Field: A “field” corresponds to an input or output entry in a form. A field can be defined with a name, a type as well as a widget (e.g., text-area, text-box, check-box, date, etc.).

FieldMapping: A FieldMapping defines the link between a data object attribute and a form field.

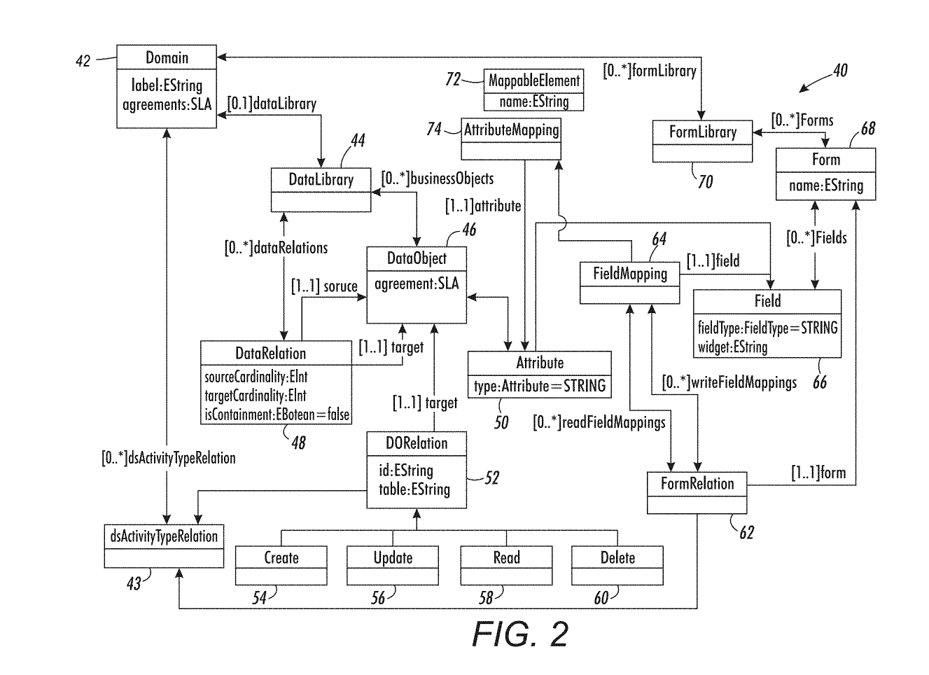

FIG. 2 illustrates a class diagram for extending a DomainMM (Domain Metal-Model) to support form externalization, in accordance with an example embodiment. The described terms, as well as their relations, are discussed below with respect to the example meta-model shown in FIG. 2. The different relations of the domain concepts, focusing on the previously defined terms, are discussed with respect to FIG. 2.

The configuration shown in FIG. 2 thus illustrates a simplified version of the DomainMM, in accordance with an example embodiment. The meta-model 40 represents the generic concepts to describe a domain information for an organization, with regard to the specification of concepts that can be reused in the business processes. The Domain MM 40 can include a variety of features and components, such as, for example, wherein the domain 42 contains a FormLibrary 70, a DataLibrary 44, and a set of DSActivityTypeRelations 43. The DataLibrary component 44 contains DataObject components 46 and DataRelation components 48. The FormLibrary component 70 contains Form components 68. The DSActivityTypeRelation 43 relates to a DSActivityType. DORelation module 52 inherits from (is a) DSActivityTypeRelation, which in turn relates to the DataObject component 46. A create relation 54, an update relation 56, a read relation 58, and a delete relation 60 inherits from DORelations 52. The FormRelation component 62 also inherits from DSActivityTypeRelation 43. The DataRelation component 48 has a Data Object 46 as target and a Data Object 46 as source.

In addition, a DataObject component 46 contains Attribute components 50.

The latter relates to the AttributeMapping component 74. A FieldMapping component 64 also inherits from the AttributeMapping component 74. The FormRelation component 62 contains read and write FieldMapping components 64. The FieldMapping component 64 additionally relates to a Field 66.

A DomainMM has thus be extended to introduce the capability to define and externalize forms. The meta-classes represent new elements in a meta-model (i.e., Form-Library 70, Form 68, Field 66, FormRelation 62, and FieldMapping 64). A DomainMM is useful for several proposes: 1) to store the domain information in a central repository on the collaboration and distribution server; 2) to generate a domain editor (textual) that can be used stand-alone or embedded in a graphical editor as part of a diagram designer; or 3) to make the connection with the behavioral view specifying how process steps are going to be represented and connected to the domain. The disclosed solution ensures that all activities and all processes that refer to a particular form can be easily defined and accessed. This approach allows for user tasks to be automatically propagated to all the relevant activities and processes.

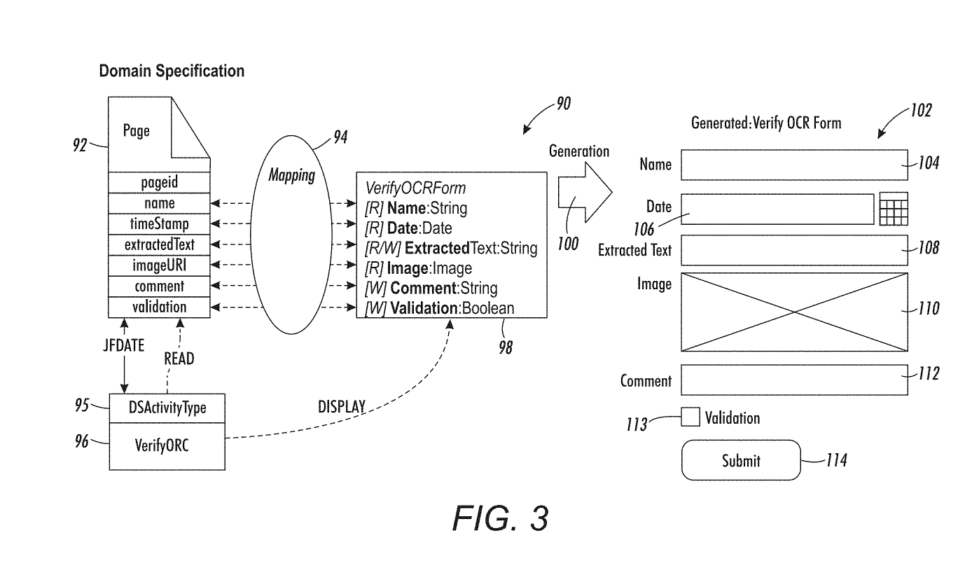

FIG. 3 illustrates a schematic diagram depicting a method 90 of form definition in the domain, in accordance with an example embodiment. In the example scenario shown in FIG. 3, a Generated_Verify OCR form 102 is depicted with various fields such as, for example, a field 104 for entering a name, a field 106 in which a date can be entered, a field 108 that can display extracted text, a field or display area 110 that can display an image, a field 112 for entering comments, a validation check box 113, and a submit button 114.

Note that the various fields, display areas, and check boxes associated with the form 102 are examples of GUI (Graphical User Interface) components that can be implemented in accordance with varying embodiments. As utilized herein, the acronym GUI or the term “Graphical User Interface” refers to a type of user interface that allows users to interact with electronic devices through graphical icons and other visual indicators such as secondary notation, instead of text-based interfaces, typed command labels, or text navigation. The actions in a GUI are usually performed through direct manipulation of the graphical elements. The term “field” as utilized herein refers generally to an input (or output) field, which is a UI (User Interface) or GUI element that provides a way to make the text of a text control editable.

The method 90 shown in FIG. 3 includes the use of a data-object which in the illustrative example is shown as a Page composed of, for example, data indicative of a page ID, a name, a time stamp, extracted text, an image URI, a comment, and a validation. A DSActivityType VerifyOCR 95 is shown as associated with Page data-object 92. A mapping 94 (referring to the FormRelation meta-class 62 in FIG. 2) is depicted in FIG. 3 between the data-object Page 92 and a Form definition 98 labeled as “VerifyOCRForm” that includes data associated with the contained fields in FIG. 3. Generated data is provided as output from the operation associated with the Form description 98, which is in put to the actual form 102.

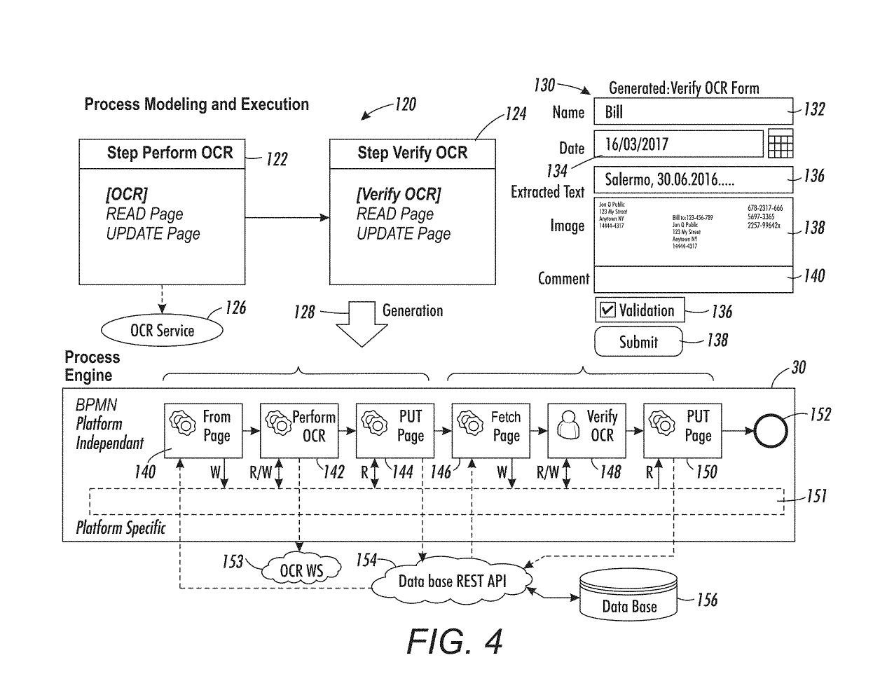

FIG. 4 illustrates a flow diagram depicting a method 120 of form display during process execution, in accordance with an example embodiment. The method 130 shown in FIG. 4 is presented in the context of an OCR scenario. It can be appreciated that other non-OCR scenarios can be implemented in accordance with the disclosed embodiments and that the embodiment depicted in FIG. 4 is merely an example presented for illustrative purposes only. Thus, in the example shown in FIG. 4, a process step 122 referring to the OCR DSActivityType is depicted indicating the performance of an example OCR operation and step 124 is referring to a DSActivityType for verifying the OCR. The step 122 indicates a call to an OCR service 126. The BPMN model composed by activities 140 (“From Page”), 142 (“Perform OCR”), 144 (“PUT Page”), 146 (“Fetch Page”), 148 (“Verify OCR”), and 150 (“PUT Page”) is generated as indicated by arrow 128 and provided to the process engine 30 (e.g., such as the process engine 30 discussed previously).

In the example shown in FIG. 4, the process engine 30 is depicted as including a process model and the data bus 151 that communicates with the activities 140 (“From Page”), 142 (“Perform OCR”), 144 (“PUT Page”), 146 (“Fetch Page”), 148 (“Verify OCR”), and 150 (“PUT Page”). Such BPMN process model is platform independent. The end of the BPMN process model is indicated by the end event 152. These activities interact with the data bus 151 with W or Write, R/W or Read/Write, and R or Read operations. The generated activities 140 (“From Page”), 144 (“PUT Page”), 146 (“Fetch Page”), and 150 (“PUT Page”) interact with the database REST API 154, which at the same time persist the data in the database 156. The generated activity 142 (“Perform OCR”) calls the actual technical web service OCR WS 153. The generated user activity 148 (“Verify OCR”) is linked to a Form 130. The example refers to the Generated_Verify OCR Form composed of various fields 132, 134, 136, 138, and 140 in addition to a validation check button 136 and a submit button 138.

The method 120 depicted in FIG. 4 demonstrates form usage definition within the process execution based on the domain. A domain expert such as the domain expert 12 shown in FIG. 1 can define the different fields and their properties (e.g., Read (R) or/and Write (W)).

The mapping between the form definition and the related data object(s) (Page in this case) will then be described with an intuitive domain specific textual language. The example corresponding to FIG. 4 is the following:

```
FormMapping {
    VerifyOCR -> VerifyDCRForm // maps activity type and form
    Read{
      attribute Page.name toField Name,
      attribute Page.timeStamp toField Date,
      attribute Page.extractedText toField ExtractedText,
      attribute Page.imageURI toField Image
    }
    Write{
      field ExtractedText write Page.extractedText,
      field Comment write Page.comment,
      field Validation write Page.validation
    }
}
```

This model describes the mapping between the data objects attributes and the fields. Note that when defining this mapping, only the data objects that are related with a READ relation with the same activity-type will be concerned in the mapping (as the scenario in FIG. 3 and in particular the mapping operation 94 demonstrates). Indeed, an auto-completion mechanism facilitates the mapping definition.

Now we turn to the form within the process execution. That is, this section presents the use of the generated forms in the process execution. It also describes a variable's life cycle from its creation until the display. FIG. 4 provides such an example.

The Perform an Optical Character Recognition (OCR) step 122 results in the generation of three BPMN activities: the first activity corresponds to a READ relation between the referred DSActivityType and the Document data object. The second activity corresponds to the actual OCR service call, also defined in the domain. Finally, the third BPMN activity corresponds to the CREATE relation with the Page data object. The generated processes will already be connected to the REST-API that deals with the process data-model. The service's parameter calls map with the read data object and the service output maps to the created or updated data object. Therefore, the data-integration effort is minimized. An equivalent reasoning is used in the Step Verify OCR. In this case, the READ relation generates a Fetch call, the relation with the Form generates the user task that displays it and finally, the UPDATE relation generates a Put activity that corresponds to the database update.

As the example shows, process users of the process will interact with the process engine in order to execute the required user activities through the generated forms.

The form externalization prototype can be integrated in the current framework. This example embodiment can be configured to rely on a set of mature and open-source Eclipse technologies, which are highly relevant for any BPM suite many of which are actually built using Eclipse.

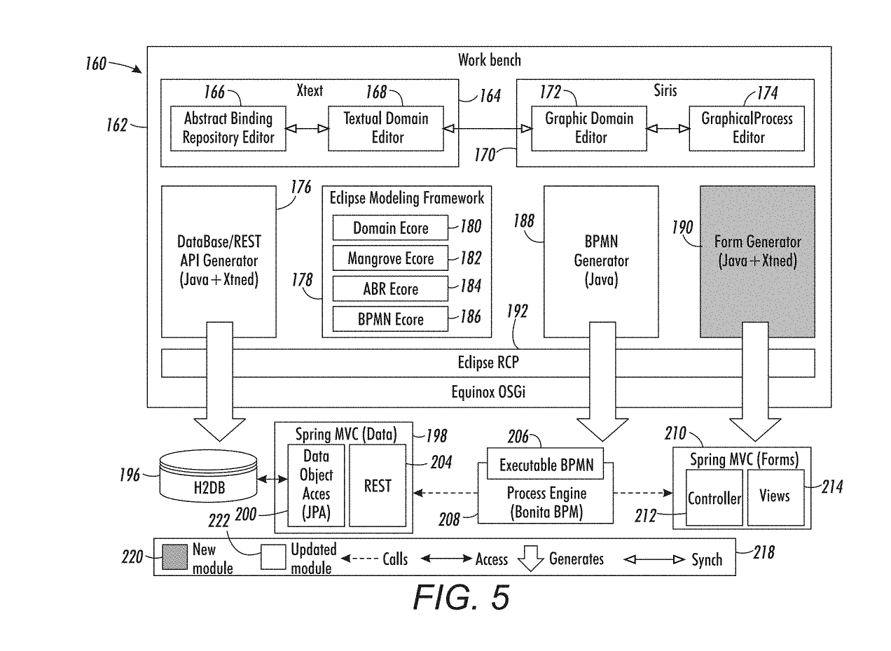

FIG. 5 illustrates a block diagram depicting a technology-oriented architecture 160, in accordance with an example embodiment. FIG. 5 depicts one possible example architecture 160 of the disclosed solution. The architecture 160 includes a workbench 162 that uses Xtext 164 and Sirius frameworks 170. Xtext 164 can be used to create an abstract binding repository editor 166 and textual domain editor 168. Sirius 170 can be used to create a graphical domain editor 172 and a graphical process editor 174. The workbench 162 additionally can include in some example embodiments, a database REST API generator 176 (i.e., corresponding to the API 154 shown in FIG. 4) and can use, for example, an Eclipse modeling framework 178 in order to define the DomainMM.ecore 180, Mangrove.ecore 182, abr.ecore 184, and BPMN.ecore 186. The workbench further includes a BMPN generator 188 and a form generator 190. The workbench 162 relies on Eclipse RCP 192 and Equinox OSGi.

The architecture 160 permits the generation of the database 196 that communicates bidirectionally with a Spring MVC that deals with data 198. The Spring MVC framework 198 is composed of a Data Object Access (using JPA) 200 and REST 204. The architecture 160 includes Spring MVC to deal with Forms 210, which includes a controller 212 and views 214. The architecture 160 permits the generation of a BPMN process model 206 that will be executed in a process engine 208. Note that the process engine 208 is similar to the process engine 30 discussed previously. Note that a legend 218 shown in FIG. 5 depicts blocks indicative of a new module 220, an updated module 222, and various other activities such as calls, access, generation (‘generates’), and synch. For example, the shaded portions of FIG. 5 represent a “new module.”

Note that in soft grey, modules highlighted are updated to support form-externalization. The dark grey elements correspond to new modules (i.e., Form Generator). The domain-specific studio relies principally on the Eclipse Rich Client Platform (RCP), which is used as backbone to support the process design and governance environment. The Eclipse RCP is contained in an Equinox (OSGI implementation). This framework provides a plug-in-based infrastructure that permits developers to build applications as a set of independent components. For instance, as the integration plug-in for a target platform is decoupled from the data and the form externalization, a company could easily enable or disable the required target platform plug-in with no impact on the domain process model or the data-model.

The Eclipse Modeling Framework (EMF) can be used for the definition of the meta-models such as the DomainMM, the MangroveMM (i.e., the processMM), the abstract binding MM, and the BPMN MM. The Mangrove MM 4 is used as the pivot meta-model that enables the link between the Domain MM and the BPMN 2.0 MM for generation purposes. On top of EMF, the Eclipse Xtext framework generates fully featured textual editor for domain descriptions relying on the DomainMM. This tool allows for an easy creation of the configurable graphical modeling studios (definition of the templates and the interpreted user interface). The BPMN 2.0 transformation and the forms can be managed by a generator coded in Java and Xtend.

As FIG. 5 shows, for the form support, we can use the Spring framework, which builds an MVC architecture where a controller dispatches the views depending on the required forms. These forms are displayed by the process engine. In the example shown in FIG. 5, as a proof of concept, BonitaBPM was used as a target engine platform. It can be appreciated, or course, that items such as “BonitaBMP” are not considered limiting features of the disclosed embodiments, but are referred to herein for illustrative purposes only.

As can be appreciated by one skilled in the art, embodiments can be implemented in the context of a method, data processing system, or computer program product. Accordingly, embodiments may take the form of an entire hardware embodiment, an entire software embodiment, or an embodiment combining software and hardware aspects all generally referred to herein as a “circuit” or “module.” Furthermore, embodiments may in some cases take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, server storage, databases, etc.

Computer program code for carrying out operations of the present invention may be written in an object-oriented programming language (e.g., Java, C++, etc.). The computer program code, however, for carrying out operations of particular embodiments may also be written in conventional procedural programming languages, such as the “C” programming language or in a visually oriented programming environment, such as, for example, Visual Basic.

The program code may execute entirely on the user's computer, partly on the user's computer, as a stand-alone software package, partly on the user's computer and partly on a remote computer, or entirely on the remote computer. In the latter scenario, the remote computer may be connected to a user's computer through a local area network (LAN) or a wide area network (WAN), wireless data network e.g., Wi-Fi, Wimax, 802.xx, and cellular network, or the connection may be made to an external computer via most third party supported networks (for example, through the Internet utilizing an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of, for example, a general-purpose computer, special-purpose computer, or other programmable data processing apparatus to produce a machine, such that the instructions, which execute via the processor of the computer or other programmable data processing apparatus, create means for implementing the functions/acts specified in the block or blocks. To be dear, the disclosed embodiments can be implemented in the context of, for example, a special-purpose computer or a general-purpose computer, or other programmable data processing apparatus or system. For example, in some embodiments, a data processing apparatus or system can be implemented as a combination of a special-purpose computer and a general-purpose computer.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

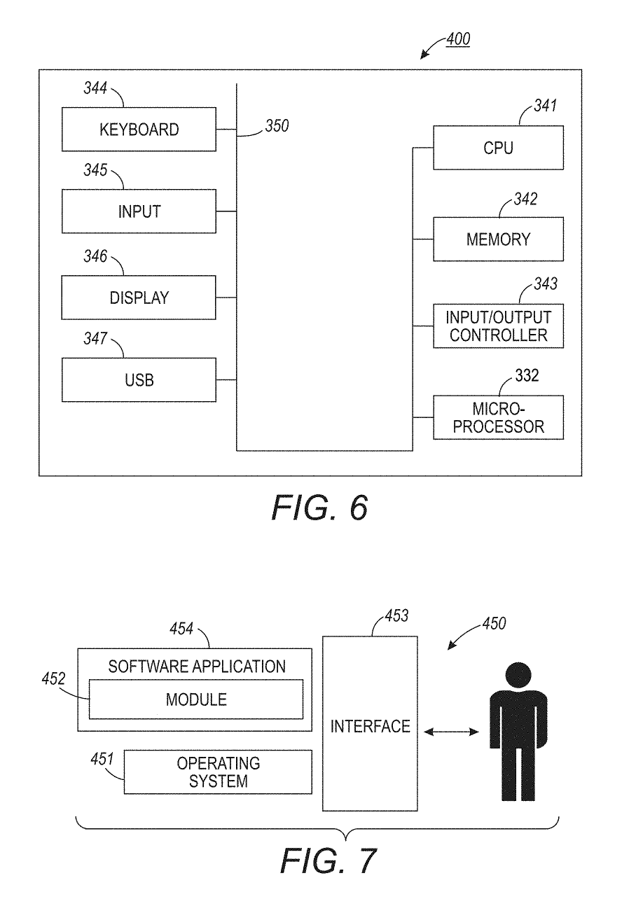

FIGS. 6-7 are shown only as exemplary diagrams of data-processing environments in which example embodiments may be implemented. It should be appreciated that FIGS. 6-7 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 6, some embodiments may be implemented in the context of a data-processing system/apparatus 400 that can include, for example, one or more processors such as a processor 341 (e.g., a CPU (Central Processing Unit) and/or other microprocessors), a memory 342, an input/output controller 343, a microcontroller 332, a peripheral USB (Universal Serial Bus) connection 347, a keyboard 344 and/or another input device 345 (e.g., a pointing device, such as a mouse, track ball, pen device, etc.), a display 346 (e.g., a monitor, touch screen display, etc.), and/or other peripheral connections and components.

As illustrated, the various components of data-processing system/apparatus 400 can communicate electronically through a system bus 350 or similar architecture. The system bus 350 may be, for example, a subsystem that transfers data between, for example, computer components within data-processing system/apparatus 400 or to and from other data-processing devices, components, computers, etc. The data-processing system/apparatus 400 may be implemented in some embodiments as, for example, a server in a client-server based network (e.g., the Internet) or in the context of a client and a server (i.e., where aspects are practiced on the client and the server).

In some example embodiments, data-processing system/apparatus 400 may be, for example, a standalone desktop computer, a laptop computer, a Smartphone, a pad computing device, and so on, wherein each such device is operably connected to and/or in communication with a client-server based network or other types of networks (e.g., cellular networks, Wi-Fi, etc.).

FIG. 7 illustrates a computer software system/apparatus 450 for directing the operation of the data-processing system/apparatus 400 depicted in FIG. 6. Software application 454, stored for example in memory 342, generally includes a kernel or operating system 451 and a shell or interface 453. One or more application programs, such as software application 454, may be “loaded” (i.e., transferred from, for example, mass storage or another memory location into the memory 342) for execution by the data-processing system/apparatus 400. The data-processing system/apparatus 400 can receive user commands and data through the interface 453; these inputs may then be acted upon by the data-processing system/apparatus 400 in accordance with instructions from operating system 451 and/or software application 454. The interface 453 in some embodiments can serve to display results, whereupon a user may supply additional inputs or terminate a session. The software application 454 can include module(s) 452, which can, for example, implement the various instructions or operations such as those discussed herein with respect to FIGS. 1-5 herein. Module 452 may also be composed of a group of modules or sub-modules that implement particular modules, such as, for example, the various modules (and components/features, etc.) discussed and illustrated herein with respect to FIGS. 1-5.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” can constitute a software application, but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

FIGS. 6-7 are thus intended as examples and not as architectural limitations of disclosed embodiments. Additionally, such embodiments are not limited to any particular application or computing or data processing environment. Instead, those skilled in the art will appreciate that the disclosed approach may be advantageously applied to a variety of systems and application software. Moreover, the disclosed embodiments can be embodied on a variety of different computing platforms, including Macintosh, UNIX, LINUX, and the like.

The claims, description, and drawings of this application may describe one or more of the instant technologies in operational/functional language, for example, as a set of operations to be performed by a computer. Such operational/functional description in most instances can be specifically configured hardware (e.g., because a general purpose computer in effect becomes a special-purpose computer once it is programmed to perform particular functions pursuant to instructions from program software). Note that the data-processing system/apparatus 400 discussed herein may be implemented as special-purpose computer in some example embodiments.

In some example embodiments, the data-processing system/apparatus 400 can be programmed to perform the aforementioned particular instructions (e.g., such as the various steps and operations described herein with respect to FIGS. 1-5 thereby becoming in effect a special-purpose computer). In other example embodiments, the data-processing system/apparatus 400 may be a general-purpose computer.

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein can be a distillation of machine specifications or other physical mechanisms specified by the operations/functions such that the otherwise inscrutable machine specifications may be comprehensible to the human mind. The distillation also allows one skilled in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions are representative of static or sequenced specifications of various hardware elements. This is true because tools available to implement technical disclosures set forth in operational/functional formats-tools in the form of a high-level programming language (e.g., C, Java, Visual Basic, etc.), or tools in the form of Very high speed Hardware Description Language (“VHDL,” which is a language that uses text to describe logic circuits)—are generators of static or sequenced specifications of various hardware configurations. The broad term “software sometimes obscures this fact” but, as shown by the following explanation, what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. In order to facilitate human comprehension, in many instances, high-level programming languages resemble or even share symbols with natural languages.

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In an example embodiment, if a high-level programming language is the tool used to implement a technical disclosure in the form of functions/operations, it can be understood that, far from being abstract, imprecise, “fuzzy,” or “mental” in any significant semantic sense, such a tool is instead a near incomprehensibly precise sequential specification of specific computational—machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory devices, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors).

The logic circuits forming the microprocessor are arranged to provide a micro architecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output.

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second).

Thus, programs written in machine language-which may be tens of millions of machine language instructions long—are incomprehensible. In view of this, early assembly languages were developed that used mnemonic codes to refer to machine language instructions rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification, which selects out hardware logic gates, specifies voltage levels, voltage transition timings, etc., such that the humanly useful work is accomplished by the hardware.

Thus, a functional/operational technical description, when viewed by one skilled in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. Accordingly, any such operational/functional technical descriptions may be understood as operations made into physical reality by: (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object, which has a stable, measurable, and changeable state may be used to construct a machine based on the above technical description. Charles Babbage, for example, constructed the first computer out of wood and powered by cranking a handle.

Thus, far from being understood as an abstract idea, it can be recognized that a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc., with natural language simply cannot be taken as an indication that such functional/operational technical descriptions are abstract ideas, or mere expressions of abstract ideas. In fact, as outlined herein, in the technological arts this is simply not true. When viewed through the tools available to those skilled in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person skilled in the art in understanding the described subject matter by providing a description that is more or less independent of any specific vendor's piece(s) of hardware.

The use of functional/operational technical descriptions assists the person skilled in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person skilled in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those skilled in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one skilled in the art can readily understand and apply in a manner independent of a specific vendor's hardware Implementation.

At least a portion of the devices or processes described herein can be Integrated into an information processing system/apparatus. An information processing system/apparatus generally includes one or more of a system unit housing, a video display device, memory, such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), or control systems including feedback loops and control motors (e.g., feedback for detecting position or velocity, control motors for moving or adjusting components or quantities). An information processing system can be implemented utilizing suitable commercially available components, such as those typically found in data computing/communication or network computing/communication systems.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes or systems or other technologies described herein can be effected (e.g., hardware, software, firmware, etc., in one or more machines or articles of manufacture), and that the preferred vehicle will vary with the context in which the processes, systems, other technologies, etc., are deployed.

For example, if an implementer determines that speed and accuracy are paramount, the implementer may opt for a mainly hardware or firmware vehicle; alternatively, if flexibility is paramount, the implementer may opt for a mainly software implementation that is implemented in one or more machines or articles of manufacture; or, yet again alternatively, the implementer may opt for some combination of hardware, software, firmware, etc., in one or more machines or articles of manufacture. Hence, there are several possible vehicles by which the processes, devices, other technologies, etc., described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. In an embodiment, optical aspects of implementations will typically employ optically-oriented hardware, software, firmware, etc., in one or more machines or articles of manufacture.

The herein described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably coupleable” to each other to achieve the desired functionality. Specific examples of operably coupleable include, but are not limited to, physically mateable, physically interacting components, wirelessly interactable, wirelessly interacting components, logically interacting, logically interactable components, etc.

In an example embodiment, one or more components may be referred to herein as “configured to,” “configurable to,” “operable/operative to,” “adapted/adaptable,” “able to,” “conformable/conformed to,” etc. Such terms (e.g., “configured to”) can generally encompass active-state components, or inactive-state components, or standby-state components, unless context requires otherwise.

The foregoing detailed description has set forth various embodiments of the devices or processes via the use of block diagrams, lowcharts, or examples. Insofar as such block diagrams, flowcharts, or examples contain one or more functions or operations, it will be understood by the reader that each function or operation within such block diagrams, flowcharts, or examples can be implemented, individually or collectively, by a wide range of hardware, software, firmware in one or more machines or articles of manufacture, or virtually any combination thereof. Further, the use of “Start,” “End,” or “Stop” blocks in the block diagrams is not intended to indicate a limitation on the beginning or end of any functions in the diagram. Such flowcharts or diagrams may be incorporated into other flowcharts or diagrams where additional functions are performed before or after the functions shown in the diagrams of this application. In an embodiment, several portions of the subject matter described herein is implemented via Application Specific Integrated Circuits (ASICs), Field Programmable Gate Arrays (FPGAs), digital signal processors (DSPs), or other integrated formats.

However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software and/or firmware would be well within the skill of one skilled in the art in light of this disclosure.

In addition, the mechanisms of the subject matter described herein are capable of being distributed as a program product in a variety of forms, and that an illustrative embodiment of the subject matter described herein applies regardless of the particular type of signal-bearing medium used to actually carry out the distribution. Non-limiting examples of a signal-bearing medium include the following: a recordable type medium such as a floppy disk, a hard disk drive, a Compact Disc (CD), a Digital Video Disk (DVD), a digital tape, a computer memory, etc.; and a transmission type medium such as a digital or an analog communication medium (e.g., a fiber optic cable, a waveguide, a wired communications link, a wireless communication link (e.g., transmitter, receiver, transmission logic, reception logic, etc.), etc.).

While particular aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Further, if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense of the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense of the convention (e.g., “a system having at least one of A, B, or C” would include but not be limited to systems that have A alone, B alone, C alone, A and B together, A and C together, B and C together, and/or A, B, and C together, etc.). Typically a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence(s), it should be understood that the various operations may be performed in orders other than those that are illustrated, or may be performed concurrently. Examples of such alternate orderings include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Based on the foregoing, it will be appreciated that a number of example embodiments are disclosed herein. For example, in one embodiment, a method for form generation and externalization in a workflow execution, can be implemented that contains steps, operations or instructions such as: mapping form fields and data attributes for at least one electronic form using a textual domain specific language, wherein the at least one electronic form is based on relations with objects; configuring the at least one electronic form with the form fields and the data attributes mapped using the textual domain specific language; and connecting the at least one electronic form to a domain specific activity so that the electronic form is thereafter consistently and repetitively reusable across a process collection. Such objects can include data objects and the generation of workflow activities can rely on the aforementioned mapping for connecting the workflow execution to a form display for displaying the at least one electronic form.

In some example embodiments, a generation mechanism can be implemented to permit a change in the at least one electronic form at a runtime without modifying a process model associated with the process collection. In still another example embodiment, a generation mechanism can be implemented to automatically link a form input and a form output associated with the at least one electronic form with a process data-flow associated with the workflow execution. In yet another example embodiment, a generation mechanism can be utilized to automatically link form inputs and outputs of the at least one electronic form with a persistent layer.

In other example embodiments, the aforementioned persistent layer can be a database. In yet another example embodiment, a step, operation, or instruction can be processed for providing a visual representation of the at least one electronic form that links the at least one electronic form to the domain specific activity.

In another example embodiment, a system for form generation and externalization in a workflow execution can be implemented. Such a system can include, for example: at least one processor; and a non-transitory computer-usable medium embodying computer program code, the computer-usable medium capable of communicating with the at least one processor. The computer program code can contain instructions executable by the at least one processor and configured for: mapping form fields and data attributes for at least one electronic form using a textual domain specific language, wherein the at least one electronic form is based on relations with objects; configuring the at least one electronic form with the form fields and the data attributes mapped using the textual domain specific language; and connecting the at least one electronic form to a domain specific activity so that the electronic form is thereafter consistently and repetitively reusable across a process collection.

In still another example embodiment, a non-transitory processor-readable medium can be implemented for storing computer code representing instructions to cause a process for form generation and externalization in a workflow execution. Such computer code can include code for: mapping form fields and data attributes for at least one electronic form using a textual domain specific language, wherein the at least one electronic form is based on relations with objects; configuring the at least one electronic form with the form fields and the data attributes mapped using the textual domain specific language; and connecting the at least one electronic form to a domain specific activity so that the electronic form is thereafter consistently and repetitively reusable across a process collection.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A method for form generation and externalization in a workflow execution, said method comprising:
mapping form fields and data attributes for at least one electronic form using a textual domain specific language, wherein said at least one electronic form is based on relations with objects;
configuring said at least one electronic form with said form fields and said data attributes mapped using said textual domain specific language; and
connecting said at least one electronic form to a domain specific activity so that said electronic form is thereafter consistently and repetitively reusable across a process collection.

2. The method of claim 1 wherein said objects comprise data objects.

3. The method of claim 1 wherein a generation of workflow activities relies on said mapping for connecting said workflow execution to a form display for displaying said at least one electronic form.

4. The method of claim 1 further comprising configuring a generation mechanism to permit a change in said at least one electronic form at a runtime without modifying a process model associated with said process collection.

5. The method of claim 1 further comprising configuring a generation mechanism to automatically link a form input and a form output associated with said at least one electronic form with a process data-flow associated with said workflow execution.

6. The method of claim 1 further comprising configuring a generation mechanism to automatically link form inputs and outputs of said at least one electronic form with a persistent layer.

7. The method of claim 6 wherein said persistent layer comprises a database.

8. The method of claim 1 further comprising providing a visual representation of said at least one electronic form that links said at least one electronic form to said domain specific activity.

9. A system for form generation and externalization in a workflow execution, said system comprising:
at least one processor, and
a non-transitory computer-usable medium embodying computer program code, said computer-usable medium capable of communicating with said at least one processor, said computer program code comprising instructions executable by said at least one processor and configured for:
mapping form fields and data attributes for at least one electronic form using a textual domain specific language, wherein said at least one electronic form is based on relations with objects;
configuring said at least one electronic form with said form fields and said data attributes mapped using said textual domain specific language; and
connecting said at least one electronic form to a domain specific activity so that said electronic form is thereafter consistently and repetitively reusable across a process collection.

10. The system of claim 9 wherein said objects comprise data objects.

11. The system of claim 9 wherein a generation of workflow activities relies on said mapping for connecting said workflow execution to a form display for displaying said at least one electronic form.

12. The system of claim 9 further comprising a generation mechanism that permits a change in said at least one electronic form at a runtime without modifying a process model associated with said process collection.

13. The system of claim 9 further comprising a generation mechanism that automatically links a form input and a form output associated with said at least one electronic form with a process data-flow associated with said workflow execution.

14. The system of claim 9 further comprising a generation mechanism that automatically links form inputs and outputs of said at least one electronic form with a persistent layer.

15. The system of claim 14 wherein said persistent layer comprises a database.

16. The system of claim 9 further comprising providing a visual representation of said at least one electronic form that links said at least one electronic form to said domain specific activity.

17. A non-transitory processor-readable medium storing computer code representing instructions to cause a process for form generation and externalization in a workflow execution, said computer code including code for:
mapping form fields and data attributes for at least one electronic form using a textual domain specific language, wherein said at least one electronic form is based on relations with objects;
configuring said at least one electronic form with said form fields and said data attributes mapped using said textual domain specific language; and
connecting said at least one electronic form to a domain specific activity so that said electronic form is thereafter consistently and repetitively reusable across a process collection.

18. The processor-readable medium of claim 17 wherein said objects comprise data objects.

19. The processor-readable medium of claim 17 wherein a generation of workflow activities relies on said mapping for connecting said workflow execution to a form display for displaying said at least one electronic form.

20. The processor-readable medium of claim 15 wherein said persistent layer comprises a database.
